(19) United States
(12) Patent Application Publication
(10) Pub. No.: US 2023/0103427 A1
(43) Pub. Date: Apr. 6, 2023

(54) OPTICAL SYSTEM, IMAGE ACQUISITION MODULE AND ELECTRONIC DEVICE

(71) Applicant: JIANGXI JINGCHAO OPTICAL CO., LTD., Nanchang (CN)

(72) Inventors: Han XIE, Nanchang (CN); Guogui WANG, Nanchang (CN); Ming LI, Nanchang (CN)

(73) Assignee: JIANGXI JINGCHAO OPTICAL CO., LTD., Nanchang (CN)

(21) Appl. No.: 17/577,297

(22) Filed: Jan. 17, 2022

(30) Foreign Application Priority Data
Sep. 29, 2021 (CN) 202111152150.0

(51) Int. Cl. H04N 5/225; G02B 13/00; G02B 9/60

(52) U.S. Cl. CPC H04N 5/2254; H04N 5/2252; G02B 13/0045; G02B 9/60

(57) ABSTRACT

The present disclosure raltes to an optical system, an image acquisition module and an electronic device. The optical system includes, successively in order from an object side to an image side: a first lens having a positive refractive power, an object side surface thereof being convex near an optical axis, an image side surface thereof being convex near the optical axis; a second lens having a negative refractive power, an object side surface thereof being convex near the optical axis, an image side surface thereof being concave near the optical axis; a third lens having a negative refractive power, an image side surface thereof being convex near the optical axis; a fourth lens having a positive refractive power; a fifth lens having a negative refractive power. The optical system satisfies the following condition: 11 mm≤f/tan(HFOV)≤12.5 mm.

### CROSS-REFERENCE TO RELATED APPLICATIONS

This application claims to the priority of Chinese Patent Application No. 2021111521500, filed on Sep. 29, 2021, the entire contents of which is incorporated herein by reference.

### TECHNICAL FIELD

The present disclosure relates to the camera field, in particular, to an optical system, an image acquisition module, and an electronic device.

### BACKGROUND

With the rapid development of electronic devices such as smart phones, tablet computers, and e-readers, the industry have increasingly demanded the camera function of electronic devices. Camera lenses with a variety of different characteristics can adapt to different application scenarios and meet different photographing requirements. The camera lens with telephoto characteristics can photograph distant scenes, and can effectively blur the background and highlight the subject, improve the imaging quality of the distant scenes, and meet the telephoto requirements.

### SUMMARY

According to various embodiments, an optical system, an image acquisition module, and an electronic device are provided.

An optical system includes, successively in order from an object side to an image side:

a first lens having a positive refractive power, an object side surface of the first lens being convex near an optical axis, an image side surface of the first lens being convex near the optical axis;

a second lens having a negative refractive power, an object side surface of the second lens being convex near the optical axis, an image side surface of the second lens being concave near the optical axis;

a third lens having a negative refractive power, an image side surface of the third lens being convex near the optical axis;

a fourth lens having a positive refractive power;

a fifth lens having a negative refractive power;

wherein the optical system satisfies the following condition:

11 mm≤f/tan(HFOV)≤12.5 mm;

wherein f is an effective focal length of the optical system, and HFOV is half of the maximum angle of field of view of the optical system.

An image acquisition module includes a photosensitive element and the optical system as described above. The photosensitive element is arranged on the image side of the optical system.

An electronic device includes a housing and the image acquisition module as described above. The image acquisition module is located on the housing.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

FIG. 1 is a schematic view of an optical system according to some embodiments of the present disclosure.

FIG. 2 is a graph showing longitudinal spherical aberration, astigmatism, and distortion of the optical system of FIG. 1.

FIG. 3 is a schematic view of an optical system according to some embodiments of the present disclosure.

FIG. 4 is a graph showing longitudinal spherical aberration, astigmatism, and distortion of the optical system of FIG. 3.

FIG. 5 is a schematic view of an optical system according to some embodiments of the present disclosure.

FIG. 6 is a graph showing longitudinal spherical aberration, astigmatism, and distortion of the optical system of FIG. 5.

FIG. 7 is a schematic view of an optical system according to some embodiments of the present disclosure.

FIG. 8 is a graph showing longitudinal spherical aberration, astigmatism, and distortion of the optical system of FIG. 7.

FIG. 9 is a schematic view of an optical system according to some embodiments of the present disclosure.

FIG. 10 is a graph showing longitudinal spherical aberration, astigmatism, and distortion of the optical system of FIG. 9.

FIG. 11 is a schematic view of an optical system according to some embodiments of the present disclosure.

FIG. 12 is a graph showing longitudinal spherical aberration, astigmatism, and distortion of the optical system of FIG. 11.

FIG. 13 a schematic view of an image acquisition module according to an embodiment of the present disclosure.

FIG. 14 is a schematic view of an electronic device according to an embodiment of the present disclosure.

### DETAILED DESCRIPTION OF THE EMBODIMENTS

In order to enable the above objects, features and advantages of the present disclosure more obvious and understandable, the specific embodiments of the present disclosure will be described in detail below with reference to the accompanying drawings. In the following description, many specific details are illustrated in order to aid in understanding of the present disclosure. However, the present disclosure can be implemented in many other ways different from those described herein, and those skilled in the art can make similar improvements without departing from the connotation of the present disclosure. Therefore, the present disclosure is not limited by the specific embodiments disclosed below.

In the description of the present disclosure, it should be understood that orientation or positional conditions indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” etc. are based on orientation or positional relationships shown in the drawings, which are merely to facilitate the description of the present disclosure and simplify the description, not to indicate or imply that the device or elements should have a particular orientation, be constructed and operated in a particular orientation, and therefore cannot be construed as a limitation on the present disclosure.

In addition, the terms “first” and “second” are used for description only, and cannot be understood as indicating or implying relative importance or implicitly indicating the number of technical features indicated. Thus, the features defined with “first” and “second” may include at least one of the features explicitly or implicitly. In the description of the present disclosure, the meaning of “plurality” is at least two, for example, two, three or the like, unless explicitly and specifically defined otherwise.

In the present disclosure, unless explicitly specified and defined otherwise, terms “mounting”, “connecting”, “connected”, and “fixing” should be understood in a broad sense. For example, it may be a fixed connection or a detachable connection, or an integration; may be a mechanical connection or electrical connection; may be a direct connection, or may be a connection through an intermediate medium, may be the communication between two elements or the interaction between two elements, unless explicitly defined otherwise. The specific meanings of the above terms in the present disclosure can be understood by one of those ordinary skills in the art according to specific circumstances.

In the present disclosure, unless expressly specified and defined otherwise, a first feature being “on” or “below” a second feature may mean that the first feature is in direct contact with the second feature, or may mean that the first feature is in indirect contact with the second feature through an intermediate medium. Moreover, the first feature being “above”, “top” and “upside” on the second feature may mean that the first feature is directly above or obliquely above the second feature, or simply mean that the level of the first feature is higher than that of the second feature. The first feature being “below”, “under” and “beneath” the second feature may mean that the first feature is directly below or obliquely below the second feature, or simply mean that the level of the first feature is smaller than that of the second feature.

It should be noted that when an element is referred to as being “fixed to” or “provided on” another element, it can be directly on another element or there may be an intermediate element therebetween. When an element is considered to be “connected to” another element, it can be directly connected to another element or there may be an intermediate element therebetween at the same time. The terms “vertical”, “horizontal”, “upper”, “lower”, “left”, “right”, and the like used herein are for illustrative purposes only and are not intended to be the only embodiments.

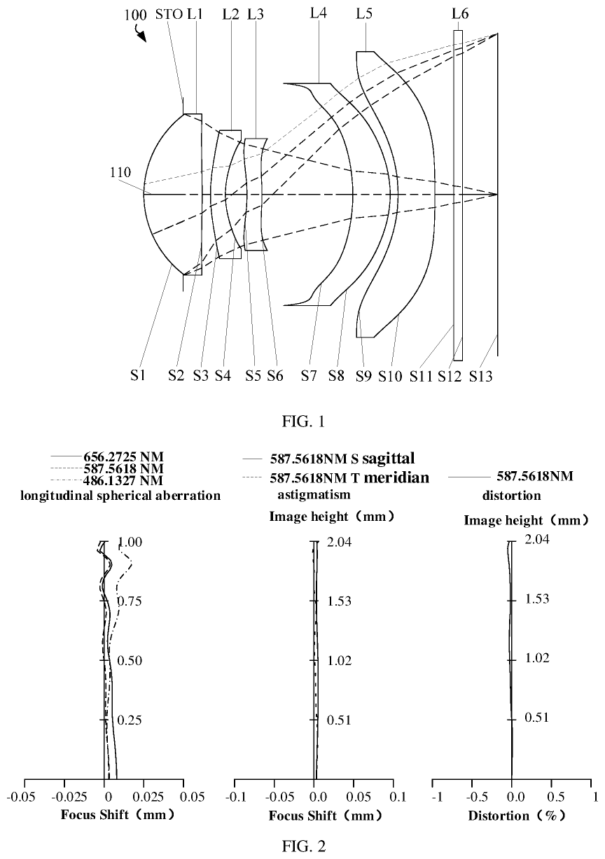

Referring to FIG. 1, according to some embodiments of the present disclosure, an optical system 100 includes, successively in order from an object side to an image side, a first lens L1, a second lens L2, a third lens L3, a fourth lens L4, and a fifth lens L5. Specifically, the first lens L1 includes an object side surface S1 and an image side surface S2. The second lens L2 includes an object side surface S3 and an image side surface S4. The third lens L3 includes an object side surface S5 and an image side surface S6. The fourth lens L4 includes an object side surface S7 and an image side surface S8. The fifth lens L5 includes an object side surface S9 and an image side surface S10. The first lens L1, the second lens L2, the third lens L3, the fourth lens L4, and the fifth lens L5 are coaxially arranged. A common axis of the lenses in the optical system 100 is an optical axis 110 of the optical system 100.

The first lens L1 has a positive refractive power, and the object side surface S1 of the first lens L1 is convex near the optical axis 110, and the image side surface S2 thereof is convex near the optical axis 110, which can effectively converge light, which is beneficial to shorten the total length of the optical system 100 and realize a miniaturized design. The second lens L2 has a negative refractive power. The object side surface S3 of the second lens L2 is convex near the optical axis 110, and the image side surface S4 thereof is concave near the optical axis 110, which can effectively balance aberrations such as spherical aberration and chromatic aberration generated by the first lens L1, which is beneficial to improve the imaging quality of the optical system 100. The third lens L3 has a negative refractive power, which can balance refractive powers of front and rear ends of the optical system 100, thereby shortening the effective aperture of each lens. The image side surface S6 of the third lens L3 is convex near the optical axis 110. The fourth lens L4 has a positive refractive power, which can share the positive refractive power of the optical system 100, which is beneficial to shorten the total length of the optical system 100, and is also beneficial to prevent the refractive power of a single lens from being too strong to reduce the molding yield of the lens. The fifth lens L5 has a negative refractive power, which is beneficial to correct the astigmatism and image curvature of the optical system 100 and improve the imaging quality of the optical system 100.

In some embodiments, the object side surface S5 of the third lens L3 is concave near the optical axis 110. The object side surface S5 of the third lens L3 is concave at a circumference thereof, and the image side surface S6 thereof is convex at the circumference thereof. With this configuration, curvatures of the object side surface S5 and the image side surface S6 of the third lens L3 from the center to the edge of the lens change in the same direction, such that the shapes of the surfaces of the third lens L3 are smooth and not distorted, which is beneficial to reduce the decentering sensitivity and is beneficial to injection molding of the third lens L3.

In some embodiments, the optical system 100 further includes an imaging plane S13 on the image side of the fifth lens L5. The incident light adjusted by the first lens L1, the second lens L2, the third lens L3, the fourth lens L4, and the fifth lens L5 can be imaged on the imaging plane S13. In some embodiments, the optical system 100 is provided with a stop STO. The stop STO may be arranged on the object side of the first lens L1. In some embodiments, the optical system 100 further includes an infrared filter L6 arranged on the image side of the fifth lens L5. The infrared filter L6 can be an infrared cut-off filter, which is used to filter out interference light and prevent the interference light from reaching the imaging plane S13 of the optical system 100 to affect normal imaging.

In some embodiments, the object side surface and the image side surface of each lens of the optical system 100 are both aspherical. The use of an aspheric structure can improve the flexibility of lens design, effectively correct spherical aberration, and improve imaging quality. In other embodiments, the object side surface and the image side surface of each lens of the optical system 100 may also be spherical. It should be noted that the above-mentioned embodiments are only examples of some embodiments of the present disclosure. In some embodiments, the surfaces of the lenses in the optical system 100 may be any combination of the spherical surface and the aspheric surface.

In some embodiments, the lenses in the optical system 100 may be made of glass or plastic. The lens made of plastic can reduce the weight of the optical system 100 and reduce the production cost, which can realize the thin and light design of the optical system 100 with the small size of the optical system 100. The lens made of glass enables the optical system 100 to have excellent optical performance and higher temperature resistance. It should be noted that the lenses in the optical system 100 can also made of any combination of glass and plastic, and not necessarily all of them are made of glass or plastic.

It should be noted that the first lens L1 can includes more than one lens. In some embodiments, there may also be two or more lenses in the first lens L1, and the two or more lenses can form a cemented lens. A surface of the cemented lens closest to the object side can be regarded as the object side surface S1, and a surface thereof closest to the image side can be regarded as the image side surface S2. Alternatively, the lenses in the first lens L1 does not form the cemented lens, but the distances between the lenses are relatively fixed. In this case, the object side surface of the lens closest to the object side is the object side surface S1, and the image side surface of the lens closest to the image side is the image side surface S2. In addition, in some embodiments, two or more lenses may also be arranged in the second lens L2, the third lens L3, the fourth lens L4, or the fifth lens L5. Any adjacent lenses may form the cemented lens, or a non-cemented lens.

Further, in some embodiments, the optical system 100 satisfies a condition: 11 mm≤f/tan(HFOV)≤12.5 mm; where f is an effective focal length of the optical system 100, and HFOV is half of the maximum angle of field of view of the optical system 100. Specifically, the value of f/tan (HFOV) can be: 11.343, 11.425, 11.538, 11.661, 11.739, 11.892, 11.955, 12.021, 12.187, or 12.262, in a unit of mm. When the above condition is satisfied, the optical system 100 has telephoto characteristics, which can effectively highlight the focus subject and blur the background during telephoto photographing, and improve the telephoto photographing performance. Moreover, when cooperating with the refractive power and surface shape design of each of the lenses, the angle of field of view of the optical system 100 can be advantageously expanded. As such, the angle of field of view of the optical system 100 is not too small while the optical system 100 has the telephoto characteristics, thereby expanding the photographing field of view. In addition, it is also beneficial to the miniaturized design of the optical system 100. If the upper limit of the above condition is exceeded, the effective focal length of the optical system 100 is too long, resulting in that the total length of the optical system 100 is difficult to be shortened, which is not beneficial to realize the miniaturized design, and thus is not beneficial to the application of the optical system 100 in portable electronic devices. If the lower limit of the condition is not reached, the effective focal length of the optical system 100 is too short, and the restitution of details of the photographed distant objects is poor, resulting in that it is difficult to meet the telephoto requirements. With the above-mentioned refractive power and surface shape characteristics and satisfying the above-mentioned condition, the optical system 100 has telephoto characteristics, can meet the miniaturized design, and has good imaging quality.

It should be noted that, in some embodiments, the optical system 100 may cooperate with a photosensitive element having a rectangular photosensitive surface. An imaging plane 13 of the optical system 100 coincides with a photosensitive surface of the photosensitive element. In this case, the effective pixel area on the imaging plane 13 of the optical system 100 has a horizontal direction and a diagonal direction, and the maximum angle of field of view of the optical system 100 can be understood as the maximum angle of field of view of the optical system 100 in the diagonal direction.

In some embodiments, the optical system 100 satisfies a condition: 11.3 mm≤f/tan(HFOV)≤12.3 mm. When the above condition is satisfied, the telephoto characteristics of the optical system 100 can be further improved and the angle of field of view of the optical system 100 can be further expanded.

In some embodiments, the optical system 100 satisfies a condition: 0.15≤f3/R32≤60; where f3 is an effective focal length of the third lens L3, and R32 is a radius of curvature of the image side surface S6 of the third lens L3 at the optical axis 110. Specifically, the value of f3/R32 can be: 0.171, 0.637, 0.992, 1.435, 1.55, 1.984, 2.651, 20.320, 30.671, or 51.318. When the above condition is satisfied, a ratio of the effective focal length to the radius of curvature of the image side surface S6 of the third lens L3 can be reasonably configured, such that the shape of the convex surface of the image side surface S6 of the third lens L3 can better balance the shape configuration of the convex surfaces of the first lens L1 and the second lens L2 toward the object side, and cooperating with the fourth lens L4 and the fifth lens L5, the effective focal length of the optical system 100 can be extended, which is beneficial to realize the telephoto characteristics. In addition, the surfaces of the third lens L3 will not be excessively curved in shape, which is beneficial to the processing and forming of the third lens L3. If the upper limit of the above condition is exceeded, the absolute value of the radius of curvature of the image side surface S6 of the third lens L3 near the optical axis 110 is too small, and the surface curvature of the image side surface S6 of the third lens L3 is large, causing the optical system 100 to have increased surface shape sensitivity, which is also not beneficial to the injection molding of the third lens L3.

In some embodiments, the optical system 100 satisfies a condition: 62≤V2+V3+V4≤68; where V2 is an Abbe number of the second lens L2 to d light, that is, an Abbe number of the second lens L2 at a wavelength of 587.5618 nm, and V3 is an Abbe number of the third lens L3 to d light, V4 is an Abbe number of the fourth lens L4 to d light. Specifically, the value of V2+V3+V4 may be: 62.273, 62.557, 62.879, 63.241, 64.558, 65.662, 65.785, 66.325, 66.793 or 67.030. When the above condition is satisfied, the sum of the Abbe numbers of the second lens L2, the third lens L3, and the fourth lens L4 can be reasonably configured, which is beneficial to improve the density difference between the material used to form the second lens L2, the third lens L3, and the fourth lens L4, and the air, which is thus beneficial to better correct the chromatic aberration of the optical system 100 and improve the resolution. If the upper limit of the above condition is exceeded, the sum of the Abbe numbers of the second lens L2, the third lens L3, and the fourth lens L4 is too large, resulting in low refractive indexes of the lens materials and weak optical path control ability, which in turn causes the light to have an insufficient deflection angle in the limited air gap, which in turn leads to the degradation of imaging quality.

In some embodiments, the object side surface S7 of the fourth lens L4 is concave near the optical axis 110, and the optical system 100 satisfies a condition: −0.5≤R41/f4≤−0.1; where R41 is a radius of curvature of the object side surface S7 of the fourth lens L4 at the optical axis 110, and f4 is an effective focal length of the fourth lens L4. Specifically, the value of R41/f4 may be: −0.465, −0.455, −0.432, −0.398, −0.355, −0.327, −0.255, −0.231, −0.205, or −0.146. When the above condition is satisfied, the shapes of the concave surface of the object side surface S7 of the fourth lens L4 can cooperate with the fifth lens L5 having the negative refractive power to extend the effective focal length of the optical system 100, which is beneficial to realize the telephoto characteristics. If the upper limit of the above condition is exceeded, the absolute value of the radius of curvature of the object side surface S7 of the fourth lens L4 is too small, and the fourth lens L4 has a large curvature near the optical axis 110, resulting in that the surface curvature of the fifth lens L5 cooperating with the fourth lens L4 also increases, which causes the light to have a larger deflection angle, which is easy to produce reflection ghosts and affect the actual photographed picture. If the lower limit of the above condition is not reached, the effective focal length of the fourth lens L4 is too small, the negative refractive power is too large, and the light diverges seriously, which is not beneficial to the improvement of resolution.

In some embodiments, the object side surface S5 of the third lens L3 is concave near the optical axis 110, and the optical system 100 satisfies a condition: −25≤(R31+R32)/(R31−R32)≤−1; where R31 is a radius of curvature of the object side surface S5 of the third lens L3 at the optical axis 110, and R32 is a radius of curvature of the image side surface S6 of the third lens L3 at the optical axis 110. Specifically, the value of (R31+R32)/(R31−R32) can be: −23.628, −20.517, −17.585, −12.352, −10.302, −9.547, −6.371, −4.39, −3.541, or −1.207. When the above condition is satisfied, with the shapes of the concave and convex surfaces of the third lens L3, the radius of curvatures and the surface shapes of the object side surface S5 and the image side surface S6 of the third lens L3 can be optimized, which is beneficial for the third lens L3 to reasonably cooperate with the positive refractive power of the first lens L1 and the negative refractive power of the second lens L2, thereby reducing the on-axis spherical aberration of the entire optical system 100. Moreover, it is beneficial to correct the direction of the optical path of the third lens L3 to the fourth lens L4, thereby helping to reduce the optical distortion.

In some embodiments, the optical system 100 satisfies a condition: 0.7≤CT4/CT5≤1.5; where CT4 is a thickness of the fourth lens L4 on the optical axis 110, and CT5 is a thickness of the fifth lens L5 on the optical axis 110. Specifically, the value of CT4/CT5 may be: 0.771, 0.785, 0.796, 0.825, 0.963, 0.998, 1.021, 1.132, 1.174, or 1.225. When the above condition is satisfied, a ratio of a center thickness of the fourth lens L4 to a center thickness of the fifth lens L5 can be reasonably configured, such that the fourth lens L4 and the fifth lens L5 are more compact, and thus the assembly requirements for the structure arrangement can be met well. Moreover, it is beneficial to improve the uniformity of the thickness configuration of the lenses in the optical system 100, which is beneficial to reduce the sensitivity, and it is also beneficial to correct the optical distortion of the external field of view of the optical system 100.

In some embodiments, the optical system 100 satisfies a condition: f123>0 mm; f45<0 mm; −0.4≤f123/f45≤−0.1; where f123 is a combined focal length of the first lens L1, the second lens L2 and the third lens L3, and f45 is a combined focal length of the fourth lens L4 and the fifth lens L5. Specifically, the value of f123/f45 can be: −0.327, −0.315, −0.289, −0.277, −0.255, −0.234, −0.210, −0.188, −0.175, or −0.163. A front lens group formed by the first lens L1, the second lens L2 and the third lens L3 provides a positive refractive power and can converge light to form images. A rear lens group formed by the fourth lens L4 and the fifth lens L5 provides a negative refractive power and can diverge light, correct aberrations, and control the light imaging distance. When the above condition is satisfied, a ratio of an effective focal length of the front lens group to an effective focal length of the rear lens group can be reasonably configured, which is beneficial to realize the telephoto characteristics of the optical system 100, and it is also beneficial to shorten the overall length of the optical system 100, thereby realizing a miniaturized design. If the upper limit of the above condition is exceeded, the refractive power of the rear lens group is too weak, which is not beneficial to the increase the effective focal length of the optical system 100, which is in turn not beneficial to realize the telephoto characteristics. If the lower limit of the above condition is not reached, the rear lens group has an excessive negative refractive power, which is not beneficial to shorten the total length of the system, which is in turn not beneficial to realize the miniaturized design.

In some embodiments, the optical system 100 satisfies a condition: 18 deg≤FOV/FNO≤22 deg; where FOV is the maximum angle of field of view of the optical system 100, and FNO is an f-number of the optical system 100. Specifically, the value of FOV/FNO can be: 18.867, 18.933, 19.220, 19.345, 19.597, 19.888, 20.342, 20.673, 21.058, or 21.346, in a numerical unit of deg. When the above condition is satisfied, a ratio of the maximum angle of field of view of the optical system 100 to the f-number can be reasonably configured, which is beneficial to expand the aperture of the optical system 100, while achieving the telephoto characteristics, so as to meet the camera requirements of high-brightness. In addition, it is beneficial to improve the imaging quality of the optical system 100, while it is beneficial to reduce the distortion of the optical system 100. If the upper limit of the above condition is exceeded, the angle of field of view of the optical system 100 is too large, resulting in excessive distortion of the off-axis field of view, resulting in distortion of the periphery of the image, and in turn, resulting in degradation of imaging performance, which is not beneficial to realize the telephoto characteristics. If the lower limit of the above condition is not reached, the f-number of the optical system 100 is too large, and the light entering the optical system 100 is relatively small, resulting in a dark image in the actual photographing and affecting the imaging quality of the optical system 100.

In some embodiments, the optical system 100 satisfies a condition: |DIST|≤1%; where DIST is the maximum of the optical distortion of the optical system 100. Specifically, the value of |DIST| can be 0.03, 0.24, 0.31, 0.38, 0.45, 0.61, 0.68, 0.75, 0.82, or 1.0, in a numerical unit is %. When the above condition is satisfied, the optical distortion of the optical system 100 is small, the real picture has high restitution, the image imaged on the edge field of view has small distortion, and thus the user has a good photographing experience.

In some embodiments, the optical system 100 satisfies a condition: |DIST|≤0.5%. When the above condition is satisfied, the distortion of the optical system 100 can be further reduced, and the imaging quality of the optical system 100 can be further improved.

A reference wavelength of the above effective focal length and combined focal length is 587.5618 nm (d light).

Based on the description of the foregoing embodiments, more specific embodiments and drawings are illustrated below for detailed description.

### First Embodiment

Referring to FIGS. 1 and 2, FIG. 1 is a schematic view of an optical system 100 according to a first embodiment. The optical system 100 includes, successively in order from an object side to an image side, a stop STO, a first lens L1 having a positive refractive power, a second lens L2 having a negatives refractive power, a third lens L3 having a negative refractive power, a fourth lens L4 having a positive refractive power, and a fifth lens L5 having a negative refractive power. FIG. 2 is a graph showing longitudinal spherical aberration, astigmatism, and distortion of the optical system 100 according to the first embodiment in order from left to right, where the reference wavelength of the astigmatism diagram and the distortion diagram is 587.5618 nm, and which are the same as other embodiments.

An object side surface S1 of the first lens L1 is convex near an optical axis 110 and convex at a circumference thereof.

An image side surface S2 of the first lens L1 is convex near the optical axis 110 and concave at the circumference thereof.

An object side surface S3 of the second lens L2 is convex near the optical axis 110 and convex at a circumference thereof.

An image side surface S4 of the second lens L2 is concave near the optical axis 110 and concave at the circumference thereof.

An object side surface S5 of the third lens L3 is concave near the optical axis 110 and convex at a circumference thereof.

An image side surface S6 of the third lens L3 is convex near the optical axis 110 and concave at the circumference thereof.

An object side surface S7 of the fourth lens L4 is concave near the optical axis 110 and concave at a circumference thereof.

An image side surface S8 of the fourth lens L4 is convex near the optical axis 110 and convex at the circumference thereof.

An object side surface S9 of the fifth lens L5 is concave near the optical axis 110 and concave at a circumference thereof.

An image side surface S10 of the fifth lens L5 is convex near the optical axis 110 and convex at the circumference thereof.

The object side surfaces and the image side surfaces of the first lens L1, the second lens L2, the third lens L3, the fourth lens L4, and the fifth lens L5 are all aspherical.

It should be noted that in this disclosure, when describing that a surface of the lens near the optical axis 110 (a central area of the surface) is convex, it can be understood that an area of this surface of the lens near the optical axis 110 is convex. When describing a surface of the lens is concave at a circumference thereof, it can be understood that an area of this surface approaching the maximum effective radius is concave. For example, when this surface is convex near the optical axis 110 and is also convex at a circumference thereof, a shape of this surface in a direction from its center (an intersection between this surface and the optical axis 110) to its edge may be completely convex, or may be firstly convex at its center and be then transitioned to be concave, and then become convex when approaching the maximum effective radius. These are only examples to illustrate the relationships between various shapes and structures (concave-convex relationships) of the surface at the optical axis 110 and at the circumference, and the various shapes and structures (concave-convex relationships) of the surface are not fully described, but other situations can be derived from the above examples.

The first lens L1, the second lens L2, the third lens L3, the fourth lens L4, and the fifth lens L5 are all made of plastic.

Further, the optical system 100 satisfies a condition: f/tan(HFOV)=11.518 mm; f is an effective focal length of the optical system 100, and HFOV is half of the maximum angle of field of view of the optical system 100. When the above condition is satisfied, the optical system 100 has telephoto characteristics, which can effectively highlight the focus subject and blur the background during telephoto photographing, and improve the telephoto photographing performance. Moreover, when cooperating with the refractive power and surface shape design of each of the lenses, the angle of field of view of the optical system 100 can be advantageously expanded. As such, the angle of field of view of the optical system 100 is not too small while the optical system 100 has the telephoto characteristics, thereby expanding the photographing field of view. In addition, it is also beneficial to the miniaturized design of the optical system 100.

The optical system 100 satisfies a condition: f3/R32=2.356; where f3 is an effective focal length of the third lens L3, and R32 is a radius of curvature of the image side surface S6 of the third lens L3 at the optical axis 110. When the above condition is satisfied, a ratio of the effective focal length to the radius of curvature of the image side surface S6 of the third lens L3 can be reasonably configured, such that the shape of the convex surface of the image side surface S6 of the third lens L3 can better balance the shape configuration of the convex surfaces of the first lens L1 and the second lens L2 toward the object side, and cooperating with the fourth lens L4 and the fifth lens L5, the effective focal length of the optical system 100 can be extended, which is beneficial to realize the telephoto characteristics. In addition, the surfaces of the third lens L3 will not be excessively curved in shape, which is beneficial to the processing and forming of the third lens L3.

The optical system 100 satisfies a condition: V2+V3+V4=64.270; where V2 is an Abbe number of the second lens L2 to d light, that is, an Abbe number of the second lens L2 at a wavelength of 587.5618 nm, and V3 is an Abbe number of the third lens L3 to d light, V4 is an Abbe number of the fourth lens L4 to d light. When the above condition is satisfied, the sum of the Abbe numbers of the second lens L2, the third lens L3, and the fourth lens L4 can be reasonably configured, which is beneficial to improve the density difference between the material used to form the second lens L2, the third lens L3, and the fourth lens L4, and the air, which is thus beneficial to better correct the chromatic aberration of the optical system 100 and improve the resolution.

The optical system 100 satisfies a condition: R41/f4=−0.465; where R41 is a radius of curvature of the object side surface S7 of the fourth lens L4 at the optical axis 110, and f4 is an effective focal length of the fourth lens L4. When the above condition is satisfied, the shapes of the concave surface of the object side surface S7 of the fourth lens L4 can cooperate with the fifth lens L5 having the negative refractive power to extend the effective focal length of the optical system 100, which is beneficial to realize the telephoto characteristics.

The optical system 100 satisfies a condition: (R31+R32)/(R31−R32)=−3.844; where R31 is a radius of curvature of the object side surface S5 of the third lens L3 at the optical axis 110, and R32 is a radius of curvature of the image side surface S6 of the third lens L3 at the optical axis 110. When the above condition is satisfied, with the shapes of the concave and convex surfaces of the third lens L3, the radius of curvatures and the surface shapes of the object side surface S5 and the image side surface S6 of the third lens L3 can be optimized, which is beneficial for the third lens L3 to reasonably cooperate with the positive refractive power of the first lens L1 and the negative refractive power of the second lens L2, thereby reducing the on-axis spherical aberration of the entire optical system 100. Moreover, it is beneficial to correct the direction of the optical path of the third lens L3 to the fourth lens L4, thereby helping to reduce the optical distortion.

The optical system 100 satisfies a condition: CT4/CT5=1.015; where CT4 is a thickness of the fourth lens L4 on the optical axis 110, and CT5 is a thickness of the fifth lens L5 on the optical axis 110. When the above condition is satisfied, a ratio of a center thickness of the fourth lens L4 to a center thickness of the fifth lens L5 can be reasonably configured, such that the fourth lens L4 and the fifth lens L5 are more compact, and thus the assembly requirements for the structure arrangement can be met well. Moreover, it is beneficial to improve the uniformity of the thickness configuration of the lenses in the optical system 100, which is beneficial to reduce the sensitivity, and it is also beneficial to correct the optical distortion of the external field of view of the optical system 100.

The optical system 100 satisfies a condition: f123>0 mm; f45<0 mm; f123/f45=−0.327; where f123 is a combined focal length of the first lens L1, the second lens L2 and the third lens L3, and f45 is a combined focal length of the fourth lens L4 and the fifth lens L5. A front lens group formed by the first lens L1, the second lens L2 and the third lens L3 provides a positive refractive power and can converge light to form images. A rear lens group formed by the fourth lens L4 and the fifth lens L5 provides a negative refractive power and can diverge light, correct aberrations, and control the light imaging distance. When the above condition is satisfied, a ratio of an effective focal length of the front lens group to an effective focal length of the rear lens group can be reasonably configured, which is beneficial to realize the telephoto characteristics of the optical system 100, and it is also beneficial to shorten the overall length of the optical system 100, thereby realizing a miniaturized design.

The optical system 100 satisfies a condition: FOV/FNO=18.867 deg; where FOV is the maximum angle of field of view of the optical system 100, and FNO is an f-number of the optical system 100. When the above condition is satisfied, a ratio of the maximum angle of field of view of the optical system 100 to the f-number can be reasonably configured, which is beneficial to expand the aperture of the optical system 100, while achieving the telephoto characteristics, so as to meet the camera requirements of high-brightness. In addition, it is beneficial to improve the imaging quality of the optical system 100, while it is beneficial to reduce the distortion of the optical system 100.

The optical system 100 satisfies a condition: |DIST|=0.03%; where DIST is the maximum of the optical distortion of the optical system 100. When the above condition is satisfied, the optical distortion of the optical system 100 is small, the real picture has high restitution, the image imaged on the edge field of view has small distortion, and thus the user has a good photographing experience.

In addition, parameters of the optical system 100 are shown in Table 1. The elements from the object plane (not shown in figures) to the image plane 13 are arranged in the order of the elements in Table 1 from top to bottom. The Y radius in Table 1 is the radius of curvature of the object side surface or image side surface indicated by corresponding surface number at the optical axis 110. The surface numbers 1 and 2 indicate the object side surface S1 and the image side surface S2 of the first lens L1, respectively. That is, in the same lens, the surface with the smaller surface number is the object side surface, and the surface with the larger surface number is the image side surface. In the “thickness” parameter column of the first lens, the first value is the thickness of this lens on the optical axis 110, and the second value is a distance from the image side surface of this lens to the next surface in a direction toward the image side on the optical axis 110.

It should be noted that in this embodiment and the following various embodiments, the optical system 100 may not be provided with an infrared filter L6, but in this case, a distance from the image side surface S10 of the fifth lens L5 to the image plane S13 remains unchanged.

In the first embodiment, the effective focal length of the optical system 100 is indicated by f, and f=4.803 mm. The f-number is indicated by FNO, and FNO=2.40. The maximum angle of field of view is indicated by FOV, and FOV=45.28 deg. The total optical length is indicated by TTL, and TTL=4.50 mm. The optical system 100 has telephoto characteristics, which can meet the miniaturized design, while achieving good imaging quality and sufficient light input.

The reference wavelengths of the focal length, the refractive index, and the Abbe number of each lens are all 587.5618 nm, and which are the same in other embodiments.

TABLE 1
First Embodiment
f = 4.803 mm; FNO = 2.40; FOV = 45.28 deg; TTL = 4.50 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| — | Object | Spherical | Infinite | 400 | — | — | — | — |
| | Plane | | | | | | | |
| STO | Stop | Spherical | Infinite | −0.499 | — | — | — | — |
| S1 | First | Aspherical | 1.253 | 0.742 | Plastic | 1.544 | 56.114 | 2.132 |
| S2 | Lens | Aspherical | −12.422 | 0.105 | | | | |
| S3 | Second | Aspherical | 1.865 | 0.190 | Plastic | 1.661 | 20.370 | −4.075 |
| S4 | Lens | Aspherical | 1.057 | 0.274 | | | | |
| S5 | Third | Aspherical | −1.901 | 0.190 | Plastic | 1.640 | 23.530 | −7.628 |
| S6 | Lens | Aspherical | −3.238 | 1.156 | | | | |
| S7 | Fourth | Aspherical | −2.197 | 0.475 | Plastic | 1.661 | 20.370 | 4.724 |
| S8 | Lens | Aspherical | −1.400 | 0.100 | | | | |
| S9 | Fifth | Aspherical | −2.037 | 0.468 | Plastic | 1.567 | 38.000 | −3.682 |
| S10 | Lens | Aspherical | −89.704 | 0.242 | | | | |
| S11 | Infrared | Spherical | Infinite | 0.110 | Glass | 1.517 | 64.167 | — |
| S12 | Filter | Spherical | Infinite | 0.448 | | | | |
| S13 | Image | Spherical | Infinite | 0.000 | — | — | — | — |
| | Plane | | | | | | | |

Further, the aspheric coefficients of the image side surface or the object side surface of the lenses of the optical system 100 are shown in Table 2. The surface numbers of S1 to S10 indicate the image side surface or the object side surface S1 to S10, respectively. K to A20 from top to bottom respectively represent the types of aspherical coefficients, where K represents the conic coefficient, A4 represents the fourth-order aspheric coefficient, A6 represents the sixth-order aspheric coefficient, and A8 represents the eighth-order aspheric coefficient, and so on. In addition, the aspheric coefficient formula is as follows:

$$Z = \frac{c {r}^{2}}{1 + \sqrt{1 - ( k + 1 ) {c}^{2} {r}^{2}}} + {\sum }_{i} Ai {r}^{i}$$

where Z is a distance from a corresponding point on an aspheric surface to a plane tangent to a vertex of the surface, r is a distance from a corresponding point on the aspheric surface to the optical axis 110, c is a curvature of the vertex of the aspheric surface, k is a conic coefficient, and Ai is a coefficient corresponding to the i^{th} high-order term in the aspheric surface shape formula.

TABLE 2
First Embodiment
Aspheric Coefficient

| Surface Number | S1 | S2 | S3 | S4 | S5 |
|---|---|---|---|---|---|
| K | 6.092E−02 | 6.003E+01 | −1.601E+01 | −3.411E+00 | −3.593E−01 |
| A4 | −6.308E−03 | 5.448E−02 | −1.111E−03 | −1.215E−01 | 4.472E−01 |
| A6 | 3.575E−02 | 1.340E−01 | −2.032E−01 | 5.415E−01 | 3.056E−02 |
| A8 | −3.211E−01 | −1.112E+00 | 8.811E−01 | −3.992E+00 | 2.866E+00 |
| A10 | 1.321E+00 | 4.572E+00 | −2.188E+00 | 3.724E+01 | −3.520E+01 |
| A12 | −3.178E+00 | −1.195E+01 | 1.846E+00 | −1.999E+02 | 2.083E+02 |
| A14 | 4.523E+00 | 1.987E+01 | 6.520E+00 | 6.452E+02 | −7.168E+02 |
| A16 | −3.745E+00 | −2.016E+01 | −2.133E+01 | −1.208E+03 | 1.449E+03 |
| A18 | 1.645E+00 | 1.135E+01 | 2.472E+01 | 1.191E+03 | −1.608E+03 |
| A20 | −2.921E−01 | −2.702E+00 | −1.046E+01 | −4.640E+02 | 7.607E+02 |
| Surface Number | S6 | S7 | S8 | S9 | S10 |
| K | −1.626E+01 | 1.156E+00 | −1.099E−01 | −1.741E+01 | 9.900E+01 |
| A4 | 4.832E−01 | 2.977E−03 | −1.266E−02 | −4.715E−01 | −2.224E−01 |
| A6 | 1.661E−01 | 8.378E−02 | 2.871E−01 | 1.083E+00 | 2.677E−01 |
| A8 | 2.849E+00 | −3.093E−01 | −2.602E−01 | −1.690E+00 | −3.402E−01 |
| A10 | −2.994E+01 | 4.702E−01 | −4.667E−01 | 1.661E+00 | 3.190E−01 |
| A12 | 1.516E+02 | −5.540E−01 | 1.288E+00 | −1.027E+00 | −2.092E−01 |
| A14 | −4.475E+02 | 4.651E−01 | −1.328E+00 | 4.041E−01 | 9.254E−02 |
| A16 | 7.675E+02 | −2.787E−01 | 7.244E−01 | −9.877E−02 | −2.607E−02 |
| A18 | −7.133E+02 | 1.163E−01 | −2.057E−01 | 1.373E−02 | 4.185E−03 |
| A20 | 2.793E+02 | −2.277E−02 | 2.399E−02 | −8.329E−04 | −2.889E−04 |

In addition, FIG. 2 includes a longitudinal spherical aberration diagram of the optical system 100, which shows that the convergence points of light of different wavelengths deviate from the focal point after transmitting through the lenses. The ordinate of the longitudinal spherical aberration diagram represents the normalized pupil coordinator from the center of the pupil to the edge of the pupil, and the abscissa thereof represents the focus shift, that is, the distance from the imaging plane S13 to the intersection of the light and the optical axis 110 (in unit of mm). It can be seen from the longitudinal spherical aberration diagram that the deviation degrees of the convergence points of the light of various wavelength in the first embodiment tends to be the same, and the diffuse spot or chromatic halo in the imaged pictures is effectively prevented. FIG. 2 further includes an astigmatic field curves diagram of the optical system 100, where the abscissa thereof represents the focus shift, and the ordinate thereof represents the image height, in a unit of mm. In the astigmatic field curves diagram, the S curve represents the sagittal field curvature at 587.5618 nm, and the T curve represents the meridian field curvature at 587.5618 nm. It can be seen from the diagram that the field curvature of the optical system 100 is small, the field curvature and astigmatism of each field of view are well corrected, and clear imaging can be achieved at the center and edges of the field of view. FIG. 2 further includes a distortion diagram of the optical system 100. The distortion curve represents the value of the distortion corresponding to different angles of field of view, where the abscissa thereof represents the distortion value in a unit of %, and the ordinate thereof represents the image height in a unit of mm. It can be seen from the figure that the image distortion caused by the main beam is small, and the imaging quality of the system is excellent.

### Second Embodiment

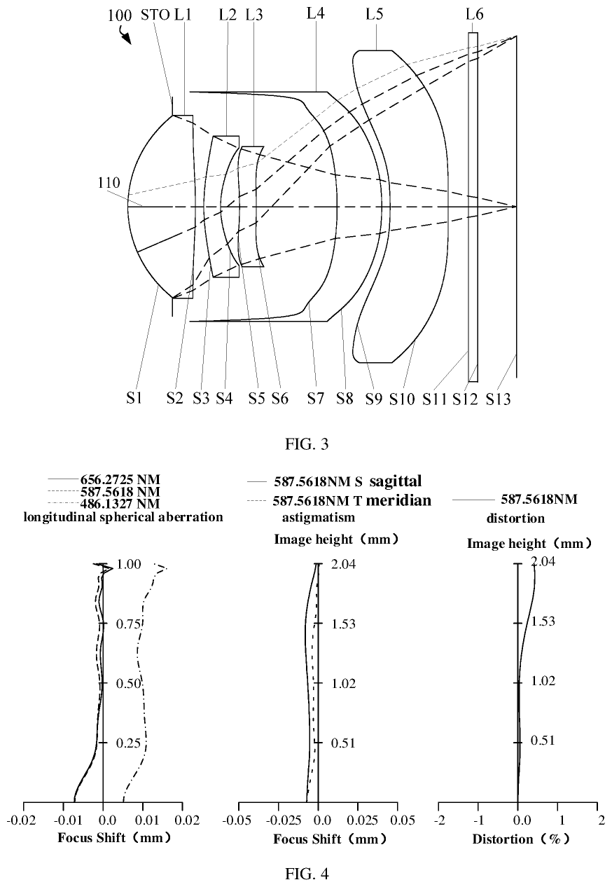

Referring to FIGS. 3 and 4, FIG. 3 is a schematic view of an optical system 100 according to a second embodiment. The optical system 100 includes, successively in order from an object side to an image side, a stop STO, a first lens L1 having a positive refractive power, a second lens L2 having a negative refractive power, a third lens L3 having a negative refractive power, a fourth lens L4 having a positive refractive power, and a fifth lens L5 having a negative refractive power. FIG. 4 is a graph showing longitudinal spherical aberration, astigmatism, and distortion of the optical system 100 according to the second embodiment in order from left to right.

An object side surface S1 of the first lens L1 is convex near an optical axis 110 and convex at a circumference thereof.

An image side surface S2 of the first lens L1 is convex near the optical axis 110 and concave at the circumference thereof.

An object side surface S3 of the second lens L2 is convex near the optical axis 110 and convex at a circumference thereof.

An image side surface S4 of the second lens L2 is concave near the optical axis 110 and concave at the circumference thereof.

An object side surface S5 of the third lens L3 is concave near the optical axis 110 and convex at a circumference thereof.

An image side surface S6 of the third lens L3 is convex near the optical axis 110 and concave at the circumference thereof.

An object side surface S7 of the fourth lens L4 is concave near the optical axis 110 and concave at a circumference thereof.

An image side surface S8 of the fourth lens L4 is convex near the optical axis 110 and convex at the circumference thereof.

An object side surface S9 of the fifth lens L5 is concave near the optical axis 110 and concave at a circumference thereof.

An image side surface S10 of the fifth lens L5 is concave near the optical axis 110 and convex at the circumference thereof.

The object side surfaces and the image side surfaces of the first lens L1, the second lens L2, the third lens L3, the fourth lens L4, and the fifth lens L5 are all aspherical.

The first lens L1, the second lens L2, the third lens L3, the fourth lens L4, and the fifth lens L5 are all made of plastic.

In addition, various parameters of the optical system 100 are shown in Table 3, and the definition of each of the parameters can be obtained from the first embodiment, which will not be repeated herein.

TABLE 3
Second Embodiment
f = 4.798 mm; FNO = 2.20; FOV = 45.85 deg; TTL = 4.66 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| — | Object | Spherical | Infinite | Infinite | — | — | — | — |
| | Plane | | | | | | | |
| STO | Stop | Spherical | Infinite | −0.535 | — | — | — | — |
| S1 | First | Aspherical | 1.342 | 0.810 | Plastic | 1.544 | 56.114 | 2.074 |
| S2 | Lens | Aspherical | −5.600 | 0.100 | | | | |
| S3 | Second | Aspherical | 2.051 | 0.201 | Plastic | 1.661 | 20.370 | −3.363 |
| S4 | Lens | Aspherical | 1.025 | 0.229 | | | | |
| S5 | Third | Aspherical | −2.881 | 0.200 | Plastic | 1.640 | 23.530 | −9.252 |
| S6 | Lens | Aspherical | −5.769 | 0.969 | | | | |
| S7 | Fourth | Aspherical | −3.592 | 0.536 | Plastic | 1.661 | 20.370 | 11.512 |
| S8 | Lens | Aspherical | −2.585 | 0.100 | | | | |
| S9 | Fifth | Aspherical | −4.309 | 0.695 | Plastic | 1.535 | 55.751 | −7.096 |
| S10 | Lens | Aspherical | 33.739 | 0.243 | | | | |
| S11 | Infrared | Spherical | Infinite | 0.110 | Glass | 1.517 | 64.167 | — |
| S12 | Filter | Spherical | Infinite | 0.467 | | | | |
| S13 | Image | Spherical | Infinite | 0.000 | — | — | — | — |
| | Plane | | | | | | | |

Further, the aspheric coefficients of the image side surface or the object side surface of the lenses of the optical system 100 are shown in Table 4, and the definition of each of the parameters can be obtained from the first embodiment, and will not be repeated herein.

TABLE 4
Second Embodiment
Aspheric Coefficient

| Surface Number | S1 | S2 | S3 | S4 | S5 |
|---|---|---|---|---|---|
| K | 8.154E−02 | −3.445E+00 | −2.852E+01 | −4.734E+00 | −4.593E+01 |
| A4 | −8.398E−03 | 8.325E−02 | 4.542E−02 | −6.120E−02 | 1.110E−01 |
| A6 | 7.590E−03 | 1.991E−01 | −2.373E−02 | 7.317E−01 | 8.513E−01 |
| A8 | −7.259E−02 | −1.343E+00 | −3.570E−01 | −2.899E+00 | −1.003E+00 |
| A10 | 2.286E−01 | 4.070E+00 | 1.404E+00 | 1.538E+01 | −3.754E+00 |
| A12 | −4.701E−01 | −7.782E+00 | −2.646E+00 | −6.682E+01 | 2.248E+01 |
| A14 | 5.877E−01 | 9.636E+00 | 2.639E+00 | 2.142E+02 | −4.349E+01 |
| A16 | −4.417E−01 | −7.465E+00 | −1.048E+00 | −4.180E+02 | 3.039E+01 |
| A18 | 1.800E−01 | 3.284E+00 | 0.000E+00 | 4.302E+02 | 0.000E+00 |
| A20 | −3.078E−02 | −6.251E−01 | 0.000E+00 | −1.725E+02 | 0.000E+00 |
| Surface Number | S6 | S7 | S8 | S9 | S10 |
| K | −9.900E+01 | 4.122E+00 | 1.699E+00 | −5.265E+01 | −9.900E+01 |
| A4 | 3.833E−01 | −4.148E−02 | −2.987E−01 | −5.964E−01 | −1.911E−01 |
| A6 | 4.938E−01 | 1.633E−01 | 7.154E−01 | 1.090E+00 | 1.723E−01 |
| A8 | −1.973E+00 | −7.202E−01 | −1.058E+00 | −1.278E+00 | −1.511E−01 |
| A10 | 1.191E+01 | 1.836E+00 | 1.090E+00 | 1.007E+00 | 1.043E−01 |
| A12 | −5.968E+01 | −3.412E+00 | −8.810E−01 | −5.211E−01 | −5.344E−02 |
| A14 | 1.919E+02 | 4.179E+00 | 5.520E−01 | 1.736E−01 | 1.934E−02 |
| A16 | −3.708E+02 | −3.188E+00 | −2.444E−01 | −3.554E−02 | −4.632E−03 |
| A18 | 3.864E+02 | 1.363E+00 | 6.505E−02 | 4.007E−03 | 6.491E−04 |
| A20 | −1.658E+02 | −2.448E−01 | −7.470E−03 | −1.856E−04 | −3.982E−05 |

According to the information of parameters described above, the following data can be derived.

| | | | |
|---|---|---|---|
| f/tan(HFOV)(mm) | 11.343 | (R31 + R32)/(R31 − R32) | −2.995 |
| f3/R32 | 1.604 | CT4/CT5 | 0.771 |
| V2 + V3 + V4 | 64.270 | f123/f45 | −0.260 |
| R41/f4 | −0.312 | FOV/FNO(deg) | 20.841 |
| \|DIST\|(%) | 0.41 | — | — |

In addition, it can be seen from the aberration diagram in FIG. 4 that the longitudinal spherical aberration, astigmatism, and distortion of the optical system 100 are well controlled, such that the optical system 100 of this embodiment has good imaging quality.

### Third Embodiment

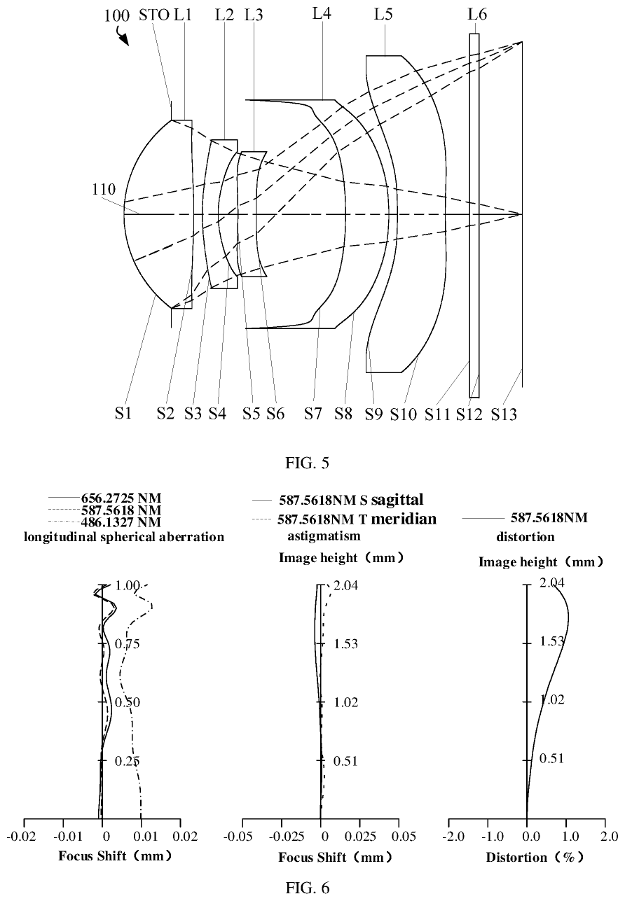

Referring to FIGS. 5 and 6, FIG. 5 is a schematic view of an optical system 100 according to a third embodiment. The optical system 100 includes, successively in order from an object side to an image side, a stop STO, a first lens L1 having a positive refractive power, a second lens L2 having a negative refractive power, a third lens L3 having a negative refractive power, a fourth lens L4 having a positive refractive power, and a fifth lens L5 having a negative refractive power. FIG. 6 is a graph showing longitudinal spherical aberration, astigmatism, and distortion of the optical system 100 according to the third embodiment in order from left to right.

An object side surface S1 of the first lens L1 is convex near an optical axis 110 and convex at a circumference thereof.

An image side surface S2 of the first lens L1 is convex near the optical axis 110 and concave at the circumference thereof.

An object side surface S3 of the second lens L2 is convex near the optical axis 110 and convex at a circumference thereof.

An image side surface S4 of the second lens L2 is concave near the optical axis 110 and concave at the circumference thereof.

An object side surface S5 of the third lens L3 is concave near the optical axis 110 and convex at a circumference thereof.

An image side surface S6 of the third lens L3 is convex near the optical axis 110 and concave at the circumference thereof.

An object side surface S7 of the fourth lens L4 is concave near the optical axis 110 and concave at a circumference thereof.

An image side surface S8 of the fourth lens L4 is convex near the optical axis 110 and convex at the circumference thereof.

An object side surface S9 of the fifth lens L5 is concave near the optical axis 110 and concave at a circumference thereof.

An image side surface S10 of the fifth lens L5 is concave near the optical axis 110 and convex at the circumference thereof.

The object side surfaces and the image side surfaces of the first lens L1, the second lens L2, the third lens L3, the fourth lens L4 and the fifth lens L5 are all aspherical.

The first lens L1, the second lens L2, the third lens L3, the fourth lens L4, and the fifth lens L5 are all made of plastic.

In addition, various parameters of the optical system 100 are shown in Table 5, and the definition of each of the parameters can be obtained from the first embodiment, which will not be repeated herein.

TABLE 5
Third Embodiment
f = 4.898 mm; FNO = 2.20; FOV = 44.95 deg; TTL = 4.70 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| — | Object | Spherical | Infinite | Infinite | — | — | — | — |
| | Plane | | | | | | | |
| STO | Stop | Spherical | Infinite | −0.557 | — | — | — | — |
| S1 | First | Aspherical | 1.368 | 0.824 | Plastic | 1.544 | 56.114 | 2.121 |
| S2 | Lens | Aspherical | −5.816 | 0.100 | | | | |
| S3 | Second | Aspherical | 2.470 | 0.187 | Plastic | 1.658 | 20.365 | −3.737 |
| S4 | Lens | Aspherical | 1.195 | 0.233 | | | | |
| S5 | Third | Aspherical | −4.041 | 0.218 | Plastic | 1.606 | 26.549 | −7.368 |
| S6 | Lens | Aspherical | −43.058 | 1.051 | | | | |
| S7 | Fourth | Aspherical | −3.544 | 0.509 | Plastic | 1.661 | 20.084 | 11.633 |
| S8 | Lens | Aspherical | −2.565 | 0.100 | | | | |
| S9 | Fifth | Aspherical | −13.425 | 0.565 | Plastic | 1.534 | 55.709 | −6.999 |
| S10 | Lens | Aspherical | 5.261 | 0.288 | | | | |
| S11 | Infrared | Spherical | Infinite | 0.110 | Glass | 1.517 | 64.167 | — |
| S12 | Filter | Spherical | Infinite | 0.512 | | | | |
| S13 | Image | Spherical | Infinite | 0.000 | — | — | — | — |
| | Plane | | | | | | | |

Further, the aspheric coefficients of the image side surface or the object side surface of the lenses of the optical system 100 are shown in Table 6, and the definition of each of the parameters can be obtained from the first embodiment, and will not be repeated herein.

TABLE 6
Third Embodiment
Aspheric Coefficient

| Surface Number | S1 | S2 | S3 | S4 | S5 |
|---|---|---|---|---|---|
| K | 9.678E−02 | −4.880E+00 | −3.331E+01 | −5.228E+00 | −7.079E+01 |
| A4 | −6.697E−03 | 1.234E−01 | 4.074E−02 | −5.599E−02 | 1.977E−01 |
| A6 | 9.333E−03 | −4.859E−02 | −1.241E−01 | 4.601E−01 | 3.957E−01 |
| A8 | −8.069E−02 | −4.808E−01 | 2.196E−01 | −6.967E−01 | −6.832E−01 |
| A10 | 2.493E−01 | 2.112E+00 | −1.430E−01 | 8.892E−01 | 1.360E−01 |
| A12 | −4.655E−01 | −4.797E+00 | −3.661E−02 | 5.504E+00 | 3.476E+00 |
| A14 | 5.047E−01 | 6.591E+00 | 1.862E−01 | −2.561E+01 | −7.886E+00 |
| A16 | −3.114E−01 | −5.439E+00 | −1.037E−01 | 5.353E+01 | 5.706E+00 |
| A18 | 9.533E−02 | 2.476E+00 | 0.000E+00 | −5.967E+01 | 0.000E+00 |
| A20 | −9.890E−03 | −4.767E−01 | 0.000E+00 | 2.995E+01 | 0.000E+00 |
| Surface Number | S6 | S7 | S8 | S9 | S10 |
| K | 9.900E+01 | 3.896E+00 | 1.695E+00 | −7.239E+01 | −3.673E+01 |
| A4 | 4.261E−01 | −2.043E−02 | −2.701E−01 | −5.644E−01 | −2.398E−01 |
| A6 | 2.789E−01 | 1.144E−01 | 7.154E−01 | 1.073E+00 | 2.796E−01 |
| A8 | −2.011E+00 | −7.515E−01 | −1.225E+00 | −1.336E+00 | −2.841E−01 |
| A10 | 1.184E+01 | 2.423E+00 | 1.545E+00 | 1.140E+00 | 2.170E−01 |
| A12 | −5.020E+01 | −5.085E+00 | −1.531E+00 | −6.605E−01 | −1.181E−01 |
| A14 | 1.363E+02 | 6.589E+00 | 1.104E+00 | 2.556E−01 | 4.374E−02 |
| A16 | −2.266E+02 | −5.101E+00 | −5.202E−01 | −6.320E−02 | −1.042E−02 |
| A18 | 2.081E+02 | 2.147E+00 | 1.380E−01 | 9.033E−03 | 1.432E−03 |
| A20 | −8.033E+01 | −3.735E−01 | −1.510E−02 | −5.675E−04 | −8.570E−05 |

According to the information of parameters described above, the following data can be derived.

| | | | |
|---|---|---|---|
| f/tan(HFOV)(mm) | 11.839 | (R31 + R32)/(R31 − R32) | −1.207 |
| f3/R32 | 0.171 | CT4/CT5 | 0.901 |
| V2 + V3 + V4 | 66.998 | f123/f45 | −0.274 |
| R41/f4 | −0.306 | FOV/FNO(deg) | 20.432 |
| \|DIST\|(%) | 1.0% | — | — |

In addition, it can be seen from the aberration diagram in FIG. 6 that the longitudinal spherical aberration, astigmatism, and distortion of the optical system 100 are well controlled, such that the optical system 100 of this embodiment has good imaging quality.

### Fourth Embodiment

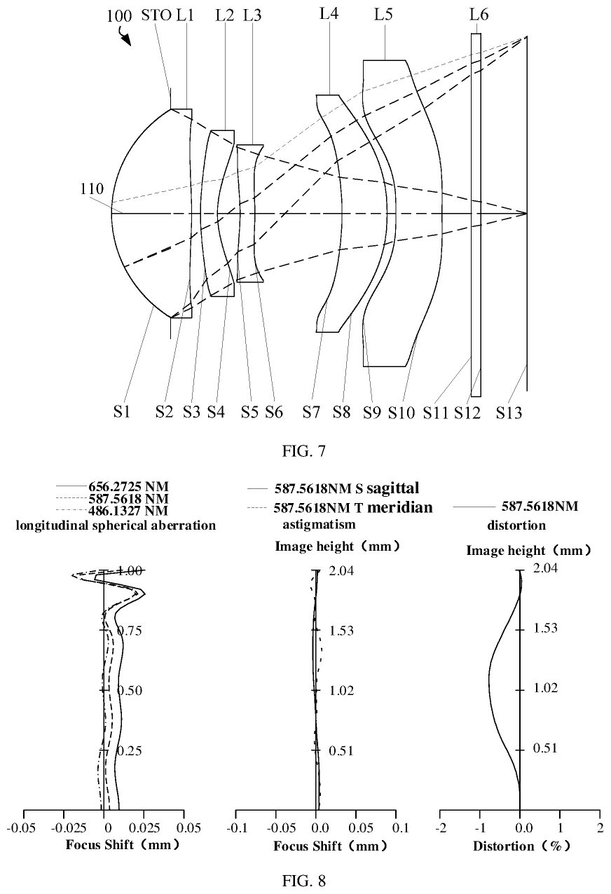

Referring to FIGS. 7 and 8, FIG. 7 is a schematic view of an optical system 100 according to a fourth embodiment. The optical system 100 includes, successively in order from an object side to an image side, a stop STO, a first lens L1 having a positive refractive power, a second lens L2 having a negative refractive power, a third lens L3 having a negative refractive power, a fourth lens L4 having a positive refractive power, and a fifth lens L5 having a negative refractive power. FIG. 8 is a graph showing longitudinal spherical aberration, astigmatism, and distortion of the optical system 100 according to the fourth embodiment in order from left to right.

An object side surface S1 of the first lens L1 is convex near an optical axis 110 and convex at a circumference thereof.

An image side surface S2 of the first lens L1 is convex near the optical axis 110 and concave at the circumference thereof.

An object side surface S3 of the second lens L2 is convex near the optical axis 110 and convex at a circumference thereof.

An image side surface S4 of the second lens L2 is concave near the optical axis 110 and concave at the circumference thereof.

An object side surface S5 of the third lens L3 is concave near the optical axis 110 and convex at a circumference thereof.

An image side surface S6 of the third lens L3 is convex near the optical axis 110 and concave at the circumference thereof.

An object side surface S7 of the fourth lens L4 is concave near the optical axis 110 and concave at a circumference thereof.

An image side surface S8 of the fourth lens L4 is convex near the optical axis 110 and convex at the circumference thereof.

An object side surface S9 of the fifth lens L5 is concave near the optical axis 110 and concave at a circumference thereof.

An image side surface S10 of the fifth lens L5 is concave near the optical axis 110 and convex at the circumference thereof.

The object side surfaces and the image side surfaces of the first lens L1, the second lens L2, the third lens L3, the fourth lens L4, and the fifth lens L5 are all aspherical.

The first lens L1, the second lens L2, the third lens L3, the fourth lens L4, and the fifth lens L5 are all made of plastic.

In addition, various parameters of the optical system 100 are shown in Table 7, and the definition of each of the parameters can be obtained from the first embodiment, which will not be repeated herein.

TABLE 7
Fourth Embodiment
f = 5.003 mm; FNO = 2.08; FOV = 44.40 deg; TTL = 4.76 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| — | Object | Spherical | Infinite | Infinite | — | — | — | — |
| | Plane | | | | | | | |
| STO | Stop | Spherical | Infinite | −0.676 | — | — | — | — |
| S1 | First | Aspherical | 1.374 | 0.916 | Plastic | 1.544 | 56.114 | 2.143 |
| S2 | Lens | Aspherical | −5.901 | 0.102 | | | | |
| S3 | Second | Aspherical | 2.572 | 0.195 | Plastic | 1.614 | 25.900 | −3.021 |
| S4 | Lens | Aspherical | 1.047 | 0.258 | | | | |
| S5 | Third | Aspherical | −3.038 | 0.170 | Plastic | 1.671 | 19.244 | −18.410 |
| S6 | Lens | Aspherical | −4.118 | 0.998 | | | | |
| S7 | Fourth | Aspherical | −3.320 | 0.517 | Plastic | 1.636 | 21.886 | 14.227 |
| S8 | Lens | Aspherical | −2.575 | 0.102 | | | | |
| S9 | Fifth | Aspherical | −5.702 | 0.527 | Plastic | 1.567 | 38.000 | −7.287 |
| S10 | Lens | Aspherical | 15.521 | 0.334 | | | | |
| S11 | Infrared | Spherical | Infinite | 0.110 | Glass | 1.517 | 64.167 | — |
| S12 | Filter | Spherical | Infinite | 0.531 | | | | |
| S13 | Image | Spherical | Infinite | 0.000 | — | — | — | — |
| | Plane | | | | | | | |

Further, the aspheric coefficients of the image side surface or the object side surface of the lenses of the optical system 100 are shown in Table 8, and the definition of each of the parameters can be obtained from the first embodiment, and will not be repeated herein.

TABLE 8
Fourth Embodiment
Aspheric Coefficient

| Surface Number | S1 | S2 | S3 | S4 | S5 |
|---|---|---|---|---|---|
| K | 4.819E−02 | −1.695E+01 | −3.907E+01 | −6.831E+00 | 0.000E+00 |
| A4 | −5.471E−03 | 5.831E−02 | −1.803E−01 | −4.491E−02 | 1.836E−01 |
| A6 | −2.529E−02 | 4.409E−01 | 1.141E+00 | 4.289E−01 | 3.080E−01 |
| A8 | 1.514E−01 | −2.290E+00 | −3.951E+00 | −1.554E+00 | 1.734E+00 |
| A10 | −5.645E−01 | 6.384E+00 | 9.200E+00 | 4.080E+00 | −2.009E+01 |
| A12 | 1.202E+00 | −1.122E+01 | −1.462E+01 | −1.184E+01 | 8.515E+01 |
| A14 | −1.535E+00 | 1.250E+01 | 1.534E+01 | 2.815E+01 | −2.091E+02 |
| A16 | 1.155E+00 | −8.495E+00 | −9.748E+00 | −4.326E+01 | 2.998E+02 |
| A18 | −4.730E−01 | 3.195E+00 | 3.196E+00 | 3.641E+01 | −2.322E+02 |
| A20 | 8.121E−02 | −5.058E−01 | −3.325E−01 | −1.232E+01 | 7.519E+01 |
| Surface Number | S6 | S7 | S8 | S9 | S10 |
| K | 0.000E+00 | 2.172E+00 | 1.378E+00 | −7.569E+00 | 6.469E+01 |
| A4 | 3.308E−01 | −1.079E−02 | −5.885E−01 | −1.034E+00 | −3.889E−01 |
| A6 | 8.407E−01 | 3.145E−01 | 2.073E+00 | 2.703E+00 | 5.608E−01 |
| A8 | −4.322E+00 | −1.173E+00 | −4.613E+00 | −5.069E+00 | −6.789E−01 |
| A10 | 2.410E+01 | 2.269E+00 | 6.549E+00 | 6.297E+00 | 5.917E−01 |
| A12 | −9.823E+01 | −2.697E+00 | −5.985E+00 | −4.907E+00 | −3.445E−01 |
| A14 | 2.568E+02 | 1.856E+00 | 3.511E+00 | 2.391E+00 | 1.303E−01 |
| A16 | −4.098E+02 | −6.813E−01 | −1.271E+00 | −7.122E−01 | −3.058E−02 |
| A18 | 3.631E+02 | 1.166E−01 | 2.552E−01 | 1.191E−01 | 4.036E−03 |
| A20 | −1.363E+02 | −6.399E−03 | −2.128E−02 | −8.598E−03 | −2.292E−04 |

According to the information of parameters described above, the following data can be derived.

| | | | |
|---|---|---|---|
| f/tan(HFOV)(mm) | 12.262 | (R31 + R32)/(R31 − R32) | −6.626 |
| f3/R32 | 4.471 | CT4/CT5 | 0.981 |
| V2 + V3 + V4 | 67.030 | f123/f45 | −0.324 |
| R41/f4 | −0.233 | FOV/FNO(deg) | 21.346 |
| \|DIST\|(%) | 0.76 | — | — |

In addition, it can be seen from the aberration diagram in FIG. 8 that the longitudinal spherical aberration, astigmatism, and distortion of the optical system 100 are well controlled, such that the optical system 100 of this embodiment has good imaging quality.

### Fifth Embodiment

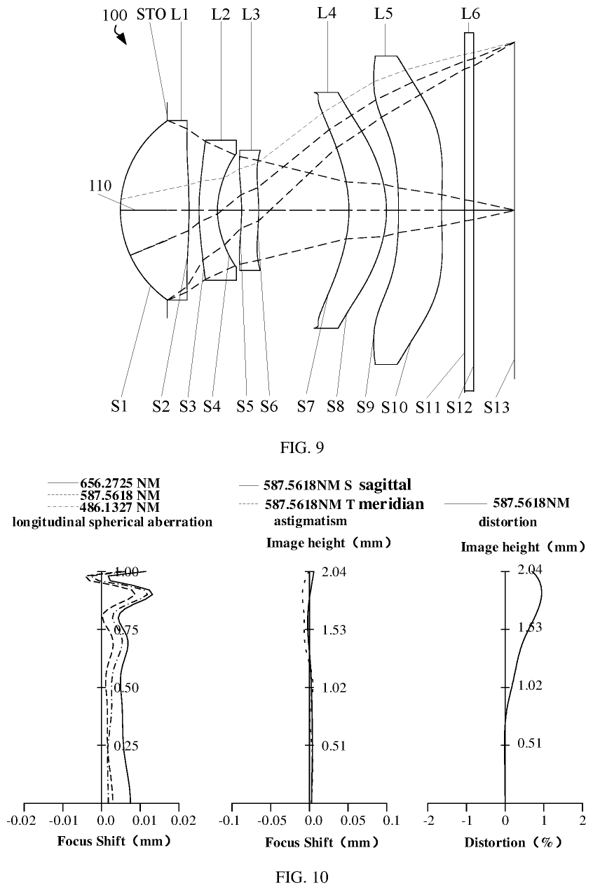

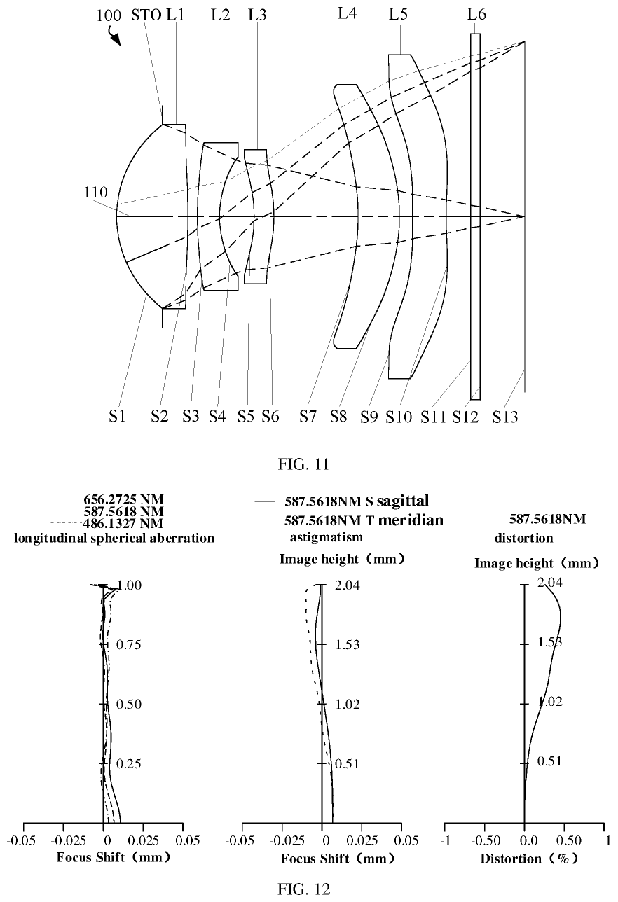

Referring to FIGS. 9 and 10, FIG. 9 is a schematic view of an optical system 100 according to a fifth embodiment. The optical system 100 includes, successively in order from an object side to an image side, a stop STO, a first lens L1 having a positive refractive power, a second lens L2 having a negative refractive power, a third lens L3 having a negative refractive power, a fourth lens L4 having a positive refractive power, and a fifth lens L5 having a negative refractive power. FIG. 10 is a graph showing longitudinal spherical aberration, astigmatism, and distortion of the optical system 100 according to the fifth embodiment in order from left to right.

An object side surface S1 of the first lens L1 is convex near an optical axis 110 and convex at a circumference thereof.

An image side surface S2 of the first lens L1 is convex near the optical axis 110 and concave at the circumference thereof.

An object side surface S3 of the second lens L2 is convex near the optical axis 110 and convex at a circumference thereof.

An image side surface S4 of the second lens L2 is concave near the optical axis 110 and concave at the circumference thereof.

An object side surface S5 of the third lens L3 is concave near the optical axis 110 and convex at a circumference thereof.

An image side surface S6 of the third lens L3 is convex near the optical axis 110 and concave at the circumference thereof.

An object side surface S7 of the fourth lens L4 is concave near the optical axis 110 and concave at a circumference thereof.

An image side surface S8 of the fourth lens L4 is convex near the optical axis 110 and convex at the circumference thereof.

An object side surface S9 of the fifth lens L5 is concave near the optical axis 110 and concave at a circumference thereof.

An image side surface S10 of the fifth lens L5 is concave near the optical axis 110 and convex at the circumference thereof.

The object side surfaces and the image side surfaces of the first lens L1, the second lens L2, the third lens L3, the fourth lens L4, and the fifth lens L5 are all aspherical.

The first lens L1, the second lens L2, the third lens L3, the fourth lens L4, and the fifth lens L5 are all made of plastic.

In addition, various parameters of the optical system 100 are shown in Table 9, and the definition of each of the parameters can be obtained from the first embodiment, which will not be repeated herein.

TABLE 9
Fifth Embodiment
f = 4.875 mm; FNO = 2.28; FOV = 44.44 deg; TTL = 4.76 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| — | Object | Spherical | Infinite | 400 | — | — | — | — |
| | Plane | | | | | | | |
| STO | Stop | Spherical | Infinite | −0.563 | — | — | — | — |
| S1 | First | Aspherical | 1.314 | 0.829 | Plastic | 1.544 | 56.114 | 2.063 |
| S2 | Lens | Aspherical | −6.008 | 0.119 | | | | |
| S3 | Second | Aspherical | 2.378 | 0.223 | Plastic | 1.636 | 23.785 | −2.482 |
| S4 | Lens | Aspherical | 0.913 | 0.293 | | | | |
| S5 | Third | Aspherical | −2.731 | 0.205 | Plastic | 1.671 | 19.244 | −68.818 |
| S6 | Lens | Aspherical | −2.990 | 1.092 | | | | |
| S7 | Fourth | Aspherical | −1.642 | 0.453 | Plastic | 1.671 | 19.244 | 8.412 |
| S8 | Lens | Aspherical | −1.413 | 0.145 | | | | |
| S9 | Fifth | Aspherical | −10.559 | 0.521 | Plastic | 1.535 | 55.751 | −6.854 |
| S10 | Lens | Aspherical | 5.715 | 0.276 | | | | |
| S11 | Infrared | Spherical | Infinite | 0.110 | Glass | 1.517 | 64.167 | — |
| S12 | Filter | Spherical | Infinite | 0.495 | | | | |
| S13 | Image | Spherical | Infinite | 0.000 | — | — | — | — |
| | Plane | | | | | | | |

Further, the aspheric coefficients of the image side surface or the object side surface of the lenses of the optical system 100 are shown in Table 10, and the definition of each of the parameters can be obtained from the first embodiment, and will not be repeated herein.

TABLE 10
Fifth Embodiment
Aspheric Coefficient

| Surface Number | S1 | S2 | S3 | S4 | S5 |
|---|---|---|---|---|---|
| K | 8.334E−02 | −3.555E+00 | −2.598E+01 | −3.452E+00 | 0.000E+00 |
| A4 | −5.380E−03 | 5.442E−02 | −2.071E−01 | −1.442E−01 | 2.378E−01 |
| A6 | 1.148E−03 | 2.801E−01 | 6.491E−01 | 1.038E+00 | 7.956E−01 |
| A8 | −6.239E−02 | −1.469E+00 | −7.786E−01 | −3.066E+00 | −4.226E+00 |
| A10 | 2.329E−01 | 4.407E+00 | −2.718E+00 | 1.693E+01 | 1.791E+01 |
| A12 | −4.646E−01 | −8.857E+00 | 1.527E+01 | −9.359E+01 | −4.987E+01 |
| A14 | 4.899E−01 | 1.173E+01 | −3.453E+01 | 3.412E+02 | 7.235E+01 |
| A16 | −2.515E−01 | −9.696E+00 | 4.335E+01 | −7.356E+02 | −4.351E+01 |
| A18 | 3.330E−02 | 4.510E+00 | −2.932E+01 | 8.576E+02 | 0.000E+00 |
| A20 | 1.077E−02 | −8.946E−01 | 8.337E+00 | −4.167E+02 | 0.000E+00 |
| Surface Number | S6 | S7 | S8 | S9 | S10 |
| K | 0.000E+00 | 3.121E−01 | −1.532E+00 | 2.992E+00 | −3.504E+01 |
| A4 | 3.247E−01 | 1.120E−01 | −3.655E−02 | −2.819E−01 | −2.650E−01 |
| A6 | 6.115E−01 | 2.535E−01 | 4.167E−01 | 6.119E−01 | 2.899E−01 |
| A8 | −2.111E+00 | −1.263E+00 | −1.184E+00 | −1.103E+00 | −2.853E−01 |
| A10 | 6.274E+00 | 2.940E+00 | 1.714E+00 | 1.195E+00 | 1.770E−01 |
| A12 | −1.328E+01 | −4.117E+00 | −1.474E+00 | −7.659E−01 | −6.223E−02 |
| A14 | 1.372E+01 | 3.584E+00 | 7.686E−01 | 3.009E−01 | 1.050E−02 |
| A16 | −5.546E+00 | −1.870E+00 | −2.246E−01 | −7.177E−02 | −7.007E−06 |
| A18 | 0.000E+00 | 5.314E−01 | 2.898E−02 | 9.574E−03 | −2.576E−04 |
| A20 | 0.000E+00 | −6.279E−02 | −4.054E−04 | −5.489E−04 | 2.623E−05 |

According to the information of parameters described above, the following data can be derived.

| | | | |
|---|---|---|---|
| f/tan(HFOV)(mm) | 11.934 | (R31 + R32)/(R31 − R32) | −22.089 |
| f3/R32 | 23.016 | CT4/CT5 | 0.869 |
| V2 + V3 + V4 | 62.273 | f123/f45 | −0.163 |
| R41/f4 | −0.195 | FOV/FNO(deg) | 19.491 |
| \|DIST\|(%) | 0.94 | — | — |

In addition, it can be seen from the aberration diagram in FIG. 10 that the longitudinal spherical aberration, astigmatism, and distortion of the optical system 100 are well controlled, such that the optical system 100 of this embodiment has good imaging quality.

### Sixth Embodiment

Referring to FIGS. 11 and 12, FIG. 11 is a schematic view of an optical system 100 according to a sixth embodiment. The optical system 100 includes, successively in order from an object side to an image side, a stop STO, a first lens L1 having a positive refractive power, a second lens L2 having a negative refractive power, a third lens L3 having a negative refractive power, a fourth lens L4 having a positive refractive power, and a fifth lens L5 having a negative refractive power. FIG. 12 is a graph showing longitudinal spherical aberration, astigmatism, and distortion of the optical system 100 according to the sixth embodiment in order from left to right.

An object side surface S1 of the first lens L1 is convex near an optical axis 110 and convex at a circumference thereof.

An image side surface S2 of the first lens L1 is convex near the optical axis 110 and convex at the circumference thereof.

An object side surface S3 of the second lens L2 is convex near the optical axis 110 and convex at a circumference thereof.

An image side surface S4 of the second lens L2 is concave near the optical axis 110 and concave at the circumference thereof.

An object side surface S5 of the third lens L3 is concave near the optical axis 110 and concave at a circumference thereof.

An image side surface S6 of the third lens L3 is convex near the optical axis 110 and convex at the circumference thereof.

An object side surface S7 of the fourth lens L4 is concave near the optical axis 110 and concave at a circumference thereof.

An image side surface S8 of the fourth lens L4 is convex near the optical axis 110 and convex at the circumference thereof.

An object side surface S9 of the fifth lens L5 is convex near the optical axis 110 and concave at a circumference thereof.

An image side surface S10 of the fifth lens L5 is concave near the optical axis 110 and convex at the circumference thereof.

In sixth embodiment, the curvatures of the object side surface S5 and the image side surface S6 of the third lens L3 from the center to the edge of the lens change in the same direction, such that the shape of the surface of the third lens L3 is smooth and not distorted, which is beneficial to reduce the decentering sensitivity and is beneficial to the injection molding of the third lens L3.

The object side surfaces and the image side surfaces of the first lens L1, the second lens L2, the third lens L3, the fourth lens L4, and the fifth lens L5 are all aspherical.

The first lens L1, the second lens L2, the third lens L3, the fourth lens L4, and the fifth lens L5 are all made of plastic.

In addition, various parameters of the optical system 100 are shown in Table 11, and the definition of each of the parameters can be obtained from the first embodiment, which will not be repeated herein.

TABLE 11
Sixth Embodiment
f = 4.893 mm; FNO = 2.28; FOV = 45.20 deg; TTL = 4.74 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| — | Object | Spherical | Infinite | Infinite | — | — | — | — |
| | Plane | | | | | | | |
| STO | Stop | Spherical | Infinite | −0.531 | — | — | — | — |
| S1 | First | Aspherical | 1.311 | 0.827 | Plastic | 1.544 | 56.114 | 2.177 |
| S2 | Lens | Aspherical | −9.516 | 0.110 | | | | |
| S3 | Second | Aspherical | 3.188 | 0.259 | Plastic | 1.640 | 23.530 | −2.824 |
| S4 | Lens | Aspherical | 1.116 | 0.402 | | | | |
| S5 | Third | Aspherical | −1.550 | 0.230 | Plastic | 1.661 | 20.084 | −86.573 |
| S6 | Lens | Aspherical | −1.687 | 0.979 | | | | |
| S7 | Fourth | Aspherical | −2.597 | 0.479 | Plastic | 1.671 | 19.244 | 17.831 |
| S8 | Lens | Aspherical | −2.292 | 0.152 | | | | |
| S9 | Fifth | Aspherical | 27.775 | 0.391 | Plastic | 1.544 | 56.114 | −9.387 |
| S10 | Lens | Aspherical | 4.291 | 0.286 | | | | |
| S11 | Infrared | Spherical | Infinite | 0.110 | Glass | 1.517 | 64.167 | — |
| S12 | Filter | Spherical | Infinite | 0.518 | | | | |
| S13 | Image | Spherical | Infinite | 0.000 | — | — | — | — |
| | Plane | | | | | | | |

Further, the aspheric coefficients of the image side surface or the object side surface of the lenses of the optical system 100 are shown in Table 12, and the definition of each of the parameters can be obtained from the first embodiment, and will not be repeated herein.

TABLE 12
Sixth Embodiment
Aspheric Coefficient

| Surface Number | S1 | S2 | S3 | S4 | S5 |
|---|---|---|---|---|---|
| K | 5.708E−03 | 3.175E+01 | −1.326E+01 | −3.144E+00 | 4.089E−01 |
| A4 | −1.784E−03 | −3.628E−02 | −2.802E−01 | −1.114E−01 | 1.546E−01 |
| A6 | −2.637E−02 | 4.176E−01 | 9.133E−01 | 1.238E+00 | 1.843E−01 |
| A8 | 1.191E−01 | −1.403E+00 | −1.842E+00 | −8.454E+00 | 1.535E+00 |
| A10 | −3.810E−01 | 3.438E+00 | 2.481E+00 | 6.567E+01 | −1.443E+01 |
| A12 | 7.400E−01 | −6.280E+00 | −1.689E+00 | −3.411E+02 | 7.090E+01 |
| A14 | −9.137E−01 | 8.107E+00 | −9.696E−02 | 1.107E+03 | −2.198E+02 |
| A16 | 6.922E−01 | −6.854E+00 | 6.950E−01 | −2.154E+03 | 4.088E+02 |
| A18 | −2.949E−01 | 3.358E+00 | 7.275E−02 | 2.299E+03 | −4.133E+02 |
| A20 | 5.346E−02 | −7.163E−01 | −2.629E−01 | −1.033E+03 | 1.709E+02 |
| Surface Number | S6 | S7 | S8 | S9 | S10 |
| K | 5.551E−01 | 5.906E−01 | −1.491E−01 | −9.900E+01 | −6.466E+01 |
| A4 | 2.278E−01 | 8.232E−02 | −8.632E−02 | −4.354E−01 | −2.339E−01 |
| A6 | 2.019E−01 | 7.804E−02 | 4.573E−01 | 8.352E−01 | 2.656E−01 |
| A8 | 2.814E−01 | −4.035E−01 | −9.172E−01 | −1.168E+00 | −2.484E−01 |
| A10 | −1.816E+00 | 7.614E−01 | 1.055E+00 | 1.053E+00 | 1.468E−01 |
| A12 | 3.314E+00 | −8.848E−01 | −7.629E−01 | −6.004E−01 | −4.966E−02 |
| A14 | −9.582E−01 | 6.481E−01 | 3.457E−01 | 2.184E−01 | 8.266E−03 |
| A16 | −7.872E+00 | −2.847E−01 | −9.137E−02 | −4.950E−02 | −1.817E−04 |
| A18 | 1.285E+01 | 6.761E−02 | 1.184E−02 | 6.391E−03 | −1.265E−04 |
| A20 | −6.365E+00 | −6.600E−03 | −4.413E−04 | −3.598E−04 | 1.170E−05 |

According to the information of parameters described above, the following data can be derived.

| | | | |
|---|---|---|---|
| f/tan(HFOV)(mm) | 11.762 | (R31 + R32)/(R31 − R32) | −23.628 |
| f3/R32 | 51.318 | CT4/CT5 | 1.225 |
| V2 + V3 + V4 | 62.858 | f123/f45 | −0.249 |
| R41/f4 | −0.146 | FOV/FNO(deg) | 19.825 |
| \|DIST\|(%) | 0.44 | — | — |

In addition, it can be seen from the aberration diagram in FIG. 12 that the longitudinal spherical aberration, astigmatism, and distortion of the optical system 100 are well controlled, such that the optical system 100 of this embodiment has good imaging quality.

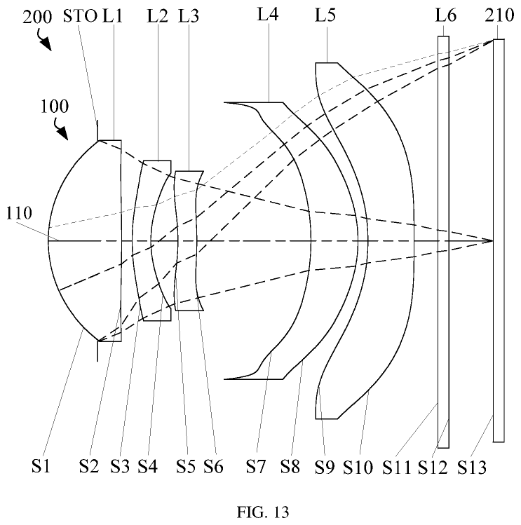

Referring to FIG. 13, in some embodiments, the optical system 100 and a photosensitive element 210 can be assembled to form an image acquisition module 200. In this case, a photosensitive surface of the photosensitive element 210 can be regard as the image plane S13 of the optical system 100. The image acquisition module 200 is provided with an infrared filter L6. The infrared filter L6 is arranged between the image side surface S10 of the fifth lens L5 and the image plane S13. Specifically, the photosensitive element 210 can be a Charge Coupled Device (CCD) or a Complementary Metal Oxide Semiconductor (CMOS) sensor. By applying the above optical system 100 in the image acquisition module 200, the image acquisition module 200 can has telephoto characteristics and the angle of field of view thereof is not too small, which can meet the miniaturized design, and achieve good imaging quality.

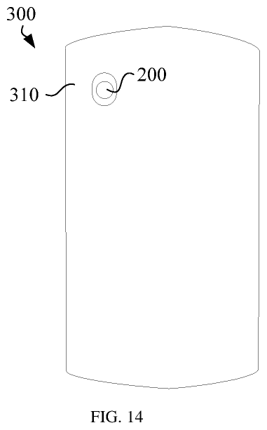

Referring to FIGS. 13 and 14, in some embodiments, the image acquisition module 200 is applied in the electronic device 300. The electronic device includes a housing 310. The image acquisition module 200 is located on the housing 310. Specifically, the electronic device 300 may be, but is not limited to, a portable phone, a video phone, a smart phone, an e-book reader, a driving recorder, or other in-vehicle camera device or a wearable device such as a smart watch. When the electronic device 300 is a smart phone, the housing 310 may be a middle frame of the electronic device 300. The image acquisition module 200 is applied in the electronic device 300, such that the electronic device 300 can have the telephoto characteristics and good imaging quality, while the angle of field of view will not be too small. The imaging module 200 can meet the miniaturized design, thereby facilitating the portable design of the electronic device 300.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variations and improvements without departing from the concept of the present disclosure, and the variations and improvements falls in the protection scope of the present disclosure. Therefore, the protection scope of the present disclosure shall be subject to the appended claims.

What is claimed is:

1. An optical system, comprising, successively in order from an object side to an image side:
a first lens having a positive refractive power, an object side surface of the first lens being convex near an optical axis, an image side surface of the first lens being convex near the optical axis;
a second lens having a negative refractive power, an object side surface of the second lens being convex near the optical axis, an image side surface of the second lens being concave near the optical axis;
a third lens having a negative refractive power, an image side surface of the third lens being convex near the optical axis;
a fourth lens having a positive refractive power;
a fifth lens having a negative refractive power;
wherein the optical system satisfies the following condition:
11 mm≤f/tan(HFOV)≤12.5 mm;
wherein f is an effective focal length of the optical system, and HFOV is half of the maximum angle of field of view of the optical system.

2. The optical system according to claim 1, further satisfying the following condition:
0.15≤f3/R32≤60;
wherein f3 is an effective focal length of the third lens, and R32 is a radius of curvature of the image side surface of the third lens at the optical axis.

3. The optical system according to claim 1, further satisfying the following condition:
62≤V2+V3+V4≤68;
where V2 is an Abbe number of the second lens to d light, V3 is an Abbe number of the third lens to d light, V4 is an Abbe number of the fourth lens to d light.

4. The optical system according to claim 1, wherein an object side surface of the fourth lens is concave near the optical axis, and the optical system further satisfies the following condition:
−0.5≤R41/f4≤−0.1;
wherein R41 is a radius of curvature of the object side surface of the fourth lens at the optical axis, and f4 is an effective focal length of the fourth lens.

5. The optical system according to claim 1, wherein an object side surface of the third lens is concave near the optical axis, and the optical system further satisfies the following condition:
−25≤(R31+R32)/(R31−R32)≤−1;
wherein R31 is a radius of curvature of the object side surface of the third lens at the optical axis, and R32 is a radius of curvature of the image side surface of the third lens at the optical axis.

6. The optical system according to claim 1, further satisfying the following condition:
0.7≤CT4/CT5≤1.5;
wherein CT4 is a thickness of the fourth lens on the optical axis, and CT5 is a thickness of the fifth lens on the optical axis.

7. The optical system according to claim 1, further satisfying the following condition:
f123>0 mm;
f45<0 mm;
−0.4≤f123/f45≤−0.1;
wherein f123 is a combined focal length of the first lens, the second lens and the third lens,
and f45 is a combined focal length of the fourth lens and the fifth lens.

8. The optical system according to claim 1, further satisfying the following condition:
18 deg≤FOV/FNO≤22 deg;
wherein FOV is the maximum angle of field of view of the optical system, and FNO is an f-number of the optical system.

9. The optical system according to claim 1, further satisfying the following condition:

|DIST|≤1%;
wherein DIST is the maximum of optical distortion of the optical system.

10. The optical system according to claim 9, further satisfying the following condition:

|DIST|≤0.5%.

11. The optical system according to claim 1, further satisfying the following condition:
11.3 mm≤f/tan(HFOV)≤12.3 mm.

12. An image acquisition module, comprising a photosensitive element and the optical system according to claim 1, wherein the photosensitive element is arranged on the image side of the optical system.

13. The image acquisition module according to claim 12, wherein the image acquisition module is provided with an infrared filter.

14. The image acquisition module according to claim 13, wherein the infrared filter is arranged between an image side surface of the fifth lens and a photosensitive surface of the photosensitive element.

15. The image acquisition module according to claim 12, wherein the photosensitive element is a Charge Coupled Device (CCD) or a Complementary Metal Oxide Semiconductor (CMOS) sensor.

16. The image acquisition module according to claim 12, wherein the optical system satisfies the following condition:
0.15≤f3/R32≤60;
wherein f3 is an effective focal length of the third lens, and R32 is a radius of curvature of the image side surface of the third lens at the optical axis.

17. The image acquisition module according to claim 12, wherein the optical system satisfies the following condition:
62≤V2+V3+V4≤68;
where V2 is an Abbe number of the second lens to d light, V3 is an Abbe number of the third lens to d light, V4 is an Abbe number of the fourth lens to d light.

18. The image acquisition module according to claim 12, wherein the optical system satisfies the following condition:
an object side surface of the fourth lens is concave near the optical axis, and the optical system further satisfies the following condition:
−0.5≤R41/f4≤−0.1;
wherein R41 is a radius of curvature of the object side surface of the fourth lens at the optical axis, and f4 is an effective focal length of the fourth lens.

19. An electronic device, comprising a housing and the image acquisition module according to claim 12, wherein the image acquisition module is located on the housing.

20. The electronic device according to claim 13, wherein the electronic device is a smart phone, the housing is a middle frame of the electronic device.
